(19) United States
(12) Patent Application Publication
(10) Pub. No.: US 2024/0175987 A1
(43) Pub. Date: May 30, 2024

(54) Light Time-of-Flight Pixel With Controllable Transfer Gate

(71) Applicants: IFM Electronic GmbH, Essen (DE); PMDTechnologies AG, Siegen (DE)

(72) Inventors: Gerrit Lükens, Siegen (DE); Robert Rössler, Berlin (DE)

(73) Assignees: IFM Electronic GmbH, Essen (DE); PMDTechnologies AG, Siegen (DE)

(21) Appl. No.: 18/282,087

(22) PCT Filed: Feb. 25, 2022
(86) PCT No.: PCT/EP2022/054850

§ 371 Date: Sep. 14, 2023

(30) Foreign Application Priority Data
Feb. 25, 2022 (DE) 10 2021 106 686.7

(51) Int. Cl. G01S 7/481; G01S 17/894

(52) U.S. Cl. CPC G01S 7/4816; G01S 17/894

(57) ABSTRACT

A light time-of-flight pixel comprising at least one modulation gate (GA, GB) having a mixing and a transfer region (TA, TB), and comprising at least one storage region (SGA, SGB), the transfer region (TA, TB) being arranged between the mixing region and the storage region (SGA, SGB), the transfer region being doped in such a way that a modulation gate voltage present at the modulation gate (GA, GB) opens or closes charge transfer to the storage region (SGA, SGB).

The time-of-flight pixel according to the invention in particular relates to all time-of-flight or 3D TOF camera systems that obtain time-of-flight information from the phase shift of emitted and received radiation. PMD cameras comprising photonic mixing detectors (PMD), such as those described in DE 197 04 496 C2, for example, are particularly suitable as time-of-flight or 3D TOF cameras. Of course, the term camera or camera system is also intended to include cameras or devices comprising at least one receiving pixel.

The figures schematically show:

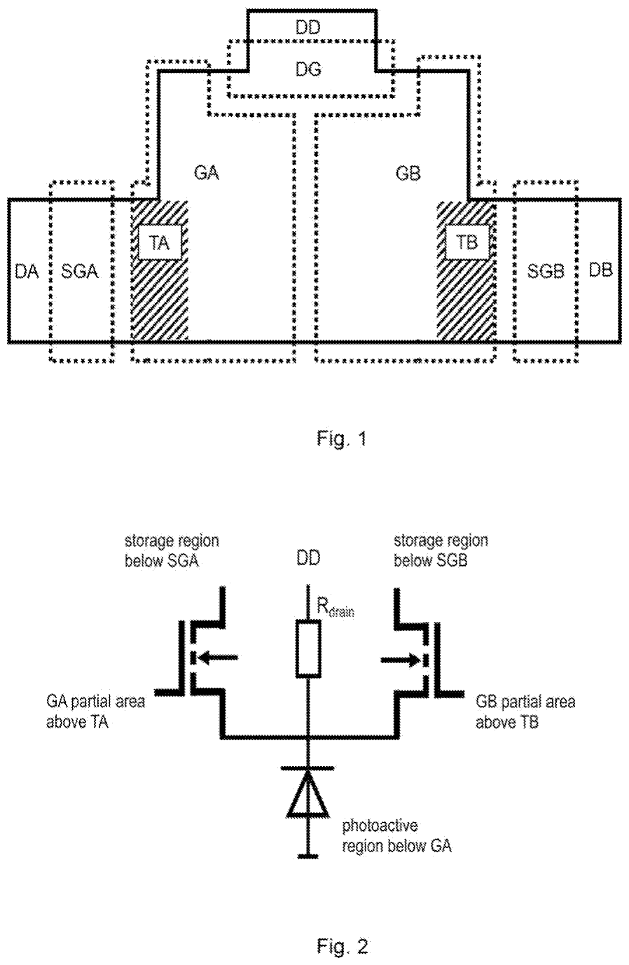

FIG. 1 a setup according to the invention;

FIG. 2 an equivalent circuit diagram of the setup according to the invention; and

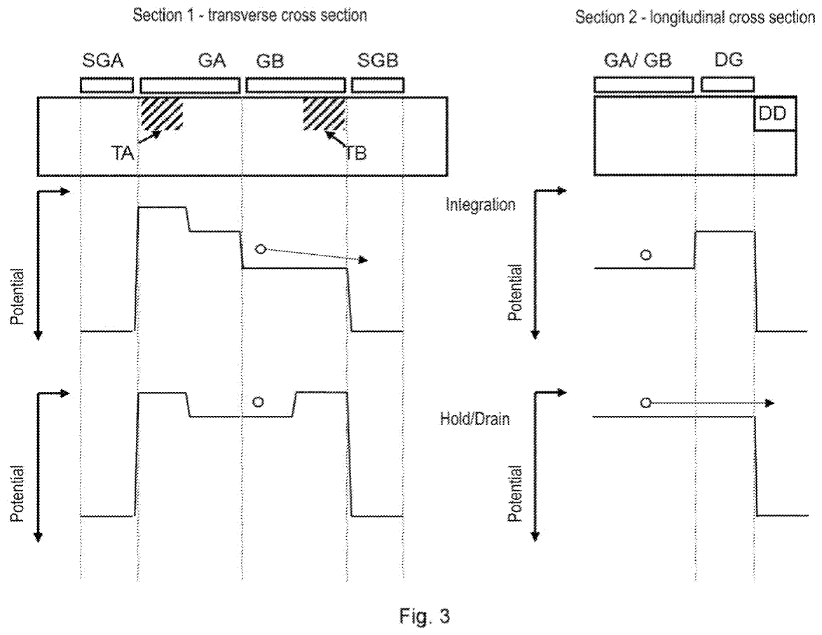

FIG. 3 a cross-section and a potential distribution of the setup according to the invention.

The core idea of the invention is to provide a time-of-flight pixel with a modified transfer region between a mixing region and a storage region, which can be controlled by the modulation gate voltage itself into an open or locked state. The proposed design of the sensor element allows for the demodulation and discharge of desired photogenerated charge carriers into the charge storage and the selective discharge of unwanted photogenerated charge carriers into a discard node. This is realized by means of defined voltage levels at the photogates. By combining different functions on the photogate, a significant reduction in space requirements is achieved.

Depending on the requirements, the charge carriers photogenerated in the absorber layer are guided into a storage region and temporarily stored there for readout, or guided into a discard node in the form of a diode and thus discarded. By use of special implants below the photogates GA and GB in the transition from the mixing region to the storage region, a controllable resistor (transfer region TA/TB) is implemented. This controllable resistor can be considered as an integrated transistor, by means of which the access to the storage region can be actively controlled into an open or locked state.

Thus, the present invention allows a very fast change between storage and discarding of the charge carriers with simultaneous minimal space requirement for the photogates. If the voltage at the modulation gates corresponds to the modulation voltage (Vmod,high or Vmod,low), the charge carriers are guided into the storage region according to the charge carrier swing. By applying the high potential (Vmod,high), the present transfer region below the modulation gate is simultaneously controlled into an open state (low impedance). By applying a low potential (Vmod,low), the corresponding transfer region below the modulation gate remains closed (high impedance) and thus prevents collection of the charge carriers in the storage node. If a low/high potential (lower than or equal to Vmod,low/higher than Vmod,high) is applied to both modulation gates, the photogenerated electrons are discharged towards the drain diode and thus discarded. This makes it possible to actively blank out light pulses over a freely selectable duration (so-called pulse skipping).

The basic structure is shown in FIG. 1. The pixel is configured of the following components
an active silicon area inside STI
dashed framed area: polysilicon gates
hatched area: locally restricted region below polysilicon gates which are described by the present invention.

The components are designated as follows:
DA/DB=integration diode, diode via which charges are read out
DD=drain diode, discharge node
GA/GB=polysilicon gate above photoactive region for targeted deflection of photogenerated charge carriers
SGA/SGB=polysilicon gate designed as a storage gate, for the intermediate storage of photogenerated charge carriers
DG=drain gate, polysilicon gate and part of the discard node
TA/TB=transfer region and controllable resistor in the transition from mixing region to storage region.

Two photogates GA and GB, which cover the photoactive mixing region and direct photogenerated charge carriers into the adjacent storage regions SGA/SGB, are de-posited on one semiconductor substrate. In the vertical direction the drain gate (DG) is disposed, which connects the mixing region directly to the drain diode DD (discard node). The controllable transfer region TA, TB of the photogates GA/GB, which is adjacent to the storage regions SGA and SGB, are doped in such a way that a controllable resistor is created in these transfer regions TA, TB. The resulting controllable resistor in the transfer region TA, TB between photogates GA, GB and storage region SGA, SGB can be regarded as an integrated transistor. A corresponding equivalent circuit is shown in FIG. 2.

This integrated transistor is set in such a way that the channel is either controlled to be open (photoelectrons are transferred into the storage region) or locked (photoelectrons are not transferred into the storage region) by the applied modulation gate voltage. The implant used to define the transfer region can be designed either as n- or p-implant. The doping concentration, implantation depth and local expansion of the implant must be set in such a way that the transfer region opens or closes depending on the modulation voltage applied and depends on the individual layout of the pixel.

The modulation gates thus have two essential functions: On the one hand the demodulation of the photogenerated charge carriers and, on the other hand, the opening and locking of the transfer region TA. TB integrated in the boundary region to the storage region SG. In principle, no additional voltage is required for the latter. For demodulation and controlling the transfer region to be open or locked it is possible to exclusively use the modulation voltages. The use of dedicated gates for opening and locking the storage region is thus not necessary, thus presenting a space-saving alternative to known designs. The basic rule is:
Rₒₙ<<R_{drain}<<R_{off}

The possibility of locking the accesses to the storage regions SGA and SGB, and thus completely preventing the collection of photogenerated charge carriers during operation, also enables to discard photogenerated charge carriers in a temporally defined manner, i.e. to guide them into a discard node. Such a discard node forms the drain gate DG and the drain diode DD which are kept at a defined potential. The setup is applicable for front side illumination as well as for back side illumination of the pixel.

FIG. 2 shows the equivalent circuit of the proposed invention. The partial areas TA, TB of the photogates GA, GB can be regarded as transistor which can be switched to high or low impedance by the modulation gate voltage. Source and drain of the transistor correspond to the photoactive region below GA/GB and the storage region below SGA/SGB. The discard node (drain gate and drain diode) corresponds to a fixed resistor in this schematic since the DD and DG voltages are not varied during integration. The following conditions regarding resistors apply during use
R(TA, TB)ₒₙ<<R_{drain}<<R(TA, TB)_{off}.

FIG. 3 shows the potential curve for the two phases of integration (collection of photogenerated charge carriers below SGA/SGB) and hold/drain (no collection below SGA/SGB) for the cross sections transverse to GA/GB toward SGA/SGB and vertically through DG. In the following, the basic functionality will be described based on the potential curves.

During integration, the modulation gates are operated at the modulation voltage. At high voltage (Vmod,high) a transfer region/integrated transistor (TA/TB) below the modulation gate (at the boundary to the storage gate SG), which is present due to special implants, is controlled to be open (shown in FIG. 3 for region TB, R(TB) low impedance). Thus, a channel is opened, in which the photogenerated charge carriers can be transferred to the storage region. At the same time, when the modulation gate voltage is low (Vmod,low) the transistor channel remains locked and thus prevents photogenerated charge carriers from entering into the channel or being discharged into the storage region (shown in FIG. 3 for region TA, R(TA) high impedance). By controlling the transistor integrated below the modulation gates into an open or locked state, the demodulation contrast can be significantly increased.

At the same time, the drain gate remains at medium potential during integration. The potential is set in such a way that during demodulation and discharge of the charge carriers into the storage regions, negligibly few charge carriers enter the drain diode (see cross section in FIG. 3).

In the hold mode, both photogates GA and GB are kept at low potential. The transfer regions of TA/TB below the modulation gates remain locked accordingly, preventing photogenerated charge carriers from entering the storage regions (see FIG. 3, Drain/Hold). The drain gate remains at medium potential as during integration and allows the excess charge carriers to be discharged by means of the connection of the mixing region to the drain diode. Switching of the drain gate is not necessary, since the discharge of charge carriers into the storage regions is excluded (see FIG. 3 cross-section). This mode finds application in the targeted discharge of photogenerated charge carriers during integration (so-called pulse skipping, i.e. targeted blanking out of detected light). At the same time, this setup allows to discard charge carriers during the matrix readout, which enables the functionality according to the principle of correlated double sampling (CDS) with simultaneous global electronic shutter (global shutter, GS). The modulation gates are switched at high frequency, allowing fast switching between the integration and the drain/hold case without the need for additional signals.

1: A time-of-flight pixel comprising:
at least one modulation gate (GA, GB), which comprises a mixing region and a transfer region (TA, TB); and
at least one storage region (SGA, SGB);
wherein the transfer region (TA, TB) is disposed between the mixing region and the storage region (SGA, SGB); and
wherein the transfer region is doped such that a modulation gate voltage applied to the modulation gate (GA, GB) opens or closes a charge transfer to the storage region (SGA, SGB).

2: The time-of-flight pixel according to claim 1, wherein the storage region(s) are each connected to readout diodes.

3: The time-of-flight pixel according to claim 1, comprising at least one drain gate (DG) for transferring charge carriers generated during a readout and hold time to a drain diode (DD) or for blanking them out for a limited time.

4: The time-of-flight pixel according to claim 3, wherein the drain diode (DD) serves to discard the charge carriers generated during the readout and hold time.

5: The time-of-flight pixel according to claim 1, wherein the time-of-flight pixel is configured for demodulation of received modulated light.

6: A time-of-flight sensor comprising at least one time-of-flight pixel according to claim 1, wherein the time-of-flight pixel is configured for front side illumination (FSI) or back side illumination (BSI).

7: A time-of-flight camera system comprising a time-of-flight sensor according to claim 6.
